(19) United States
(12) Patent Application Publication
(10) Pub. No.: US 2003/0069961 A1
(43) Pub. Date: Apr. 10, 2003

(54) Mechanism for the dynamic detection of graph based connectivity among PCI devices

(75) Inventors: Shivnandan D. Kaushik, Portland, OR (US); James B. Crossland, Banks, OR (US); Mohan J. Kumar, Aloha, OR (US); Linda J. Rankin, Portland, OR (US); David J. O'Shea, Costa Mesa, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Intel Corporation, Santa Clara, CA

(21) Appl. No.: 09/972,108

(22) Filed: Oct. 4, 2001

(51) Int. Cl. G06F 15/177; G06F 15/173

(52) U.S. Cl. 709/224; 709/220

(57) ABSTRACT

A method and apparatus for the dynamic detection of graph-based connectivity among PCI (Peripheral Component Interconnect) devices are disclosed. A connectivity capability structure of a device and a list of connection records for the device are used to determine connectivity information for the device.

### FIELD OF THE INVENTION

The present invention pertains to obtaining connectivity information. More particularly, the present invention relates to a method and apparatus for the dynamic detection of graph-based connectivity among PCI (Peripheral Component Interconnect) devices.

### BACKGROUND OF THE INVENTION

As computers become more integrated into society, the need for computer reliability, availability, and serviceability increases. The ability to “swap” out modules in a computer system without powering down or shutting down a computer system is beneficial. This “swapping” is referred to by various names, such as: hot socket, hot swap, hot addition, hot removal, hot plug capability, etc. The ability to hot plug various parts of a computer system, such as, processor(s), memory, I/O (Input/Output) boards, modules, etc. is beneficial for replacing defective parts, upgrading a system, etc.

In order for a system to handle hot swap, the system may benefit from information about what is being hot plugged. For example, if an I/O board is being replaced, the system software or the operating system (OS) should not send requests to a non-existent device. Therefore, if the OS cannot determine what is being hot plugged, this presents a problem.

### BRIEF DESCRIPTION OF THE DRAWINGS

The present invention is illustrated by way of example and not limitation in the figures of the accompanying drawings, in which like references indicate similar elements and in which:

FIG. 1 illustrates a networked computer environment;

FIG. 2 is a block diagram of a computer system;

FIG. 3 illustrates in block diagram form an embodiment for determining device connectivity;

FIG. 4 illustrates a capability structure;

FIG. 5 illustrates one embodiment of an connectivity capability structure;

FIG. 6 illustrates one embodiment of a connection record structure;

FIG. 7 illustrates in block diagram form one embodiment for determining multiple device connectivity;

FIG. 8 illustrates one embodiment of a system where the present invention may be practiced;

FIG. 9 illustrates another embodiment of a system where the present invention may be practiced;

FIG. 10 illustrates a bus hierarchy for one embodiment of a system configuration; and

FIG. 11 illustrates one embodiment of a connectivity capability structure in the configuration space; and

FIG. 12 illustrates another embodiment of a connectivity capability structure in the configuration space.

### DETAILED DESCRIPTION

A method and apparatus for the dynamic detection of graph-based connectivity among PCI (Peripheral Component Interconnect) devices are described.

For purposes of discussing the invention, it is to be understood that various terms are used by those knowledgeable in the art to describe techniques and approaches.

In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the detailed descriptions that follow may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of skill in the art will immediately appreciate that the invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

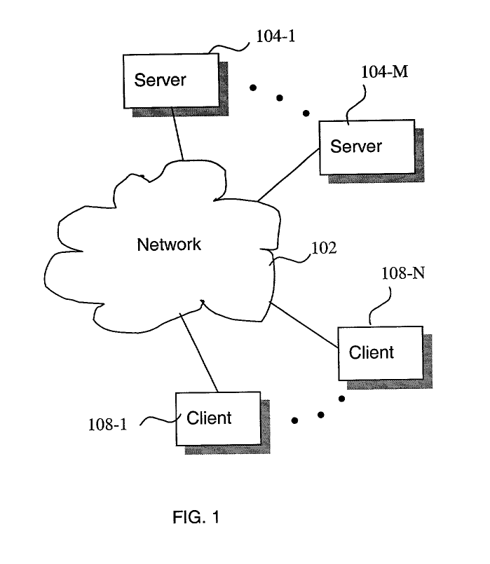

FIG. 1 illustrates a network environment in which the techniques described may be applied. As shown, several computer systems in the form of M servers 104-1 through 104-M and N clients 108-1 through 108-N are connected to each other via a network 102, which may be, for example, the Internet. Note that alternatively the network 102 might be or include one or more of: a Local Area Network (LAN), Wide Area Network (WAN), satellite link, fiber network, cable network, or a combination of these and/or others. The method and apparatus described herein may be applied to essentially any type of communicating means or device whether local or remote, such as a LAN, a WAN, a system bus, a disk drive, storage, etc.

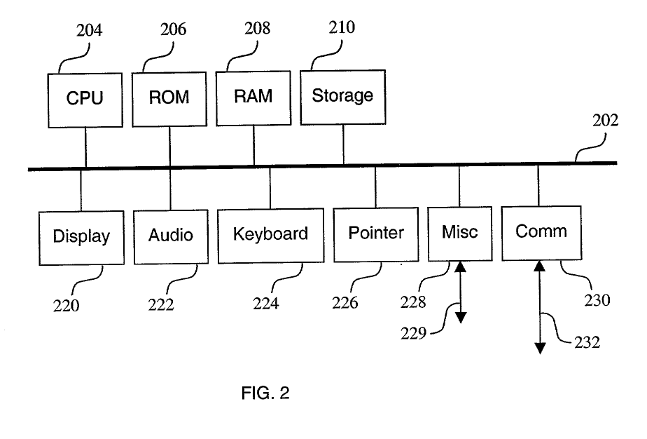

FIG. 2 illustrates a conventional personal computer in block diagram form, which may be representative of any of the clients and servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), etc. The CPU 204 may be a single, multiple, or even a distributed computing resource. The ROM 206 may be any type of non-volatile memory, which may be programmable such as, mask programmable, flash, etc. RAM 208 may be, for example, static, dynamic, synchronous, asynchronous, or any combination. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Audio 222 may be a monophonic, stereo, three dimensional sound card, etc. The keyboard 224 may be a keyboard, a musical keyboard, a keypad, a series of switches, etc. The pointer 226, may be, for example, a mouse, a touchpad, a trackball, joystick, etc. I/O devices 228, might be a voice command input device, a thumbprint input device, a smart card slot, a Personal Computer Card (PC Card) interface, virtual reality accessories, etc., which may optionally connect via an input/output port 229 to other devices or systems. An example of a miscellaneous I/O device 228 would be a Musical Instrument Digital Interface (MIDI) card with the I/O port 229 connecting to the musical instrument(s). Communications device 230 might be, for example, an Ethernet adapter for local area network (LAN) connections, a satellite connection, a settop box adapter, a Digital Subscriber Line (xDSL) adapter, a wireless modem, a conventional telephone modem, a direct telephone connection, a Hybrid-Fiber Coax (HFC) connection, cable modem, etc. The external connection port 232 may provide for any interconnection, as needed, between a remote device and the bus system 202 through the communications device 230. For example, the communications device 230 might be an Ethernet adapter, which is connected via the connection port 232 to, for example, an external DSL modem. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

Referring back to FIG. 1, clients 108-1 through 108-N are effectively connected to web sites, application service providers, search engines, and/or database resources represented by servers, such as servers 104-1 through 104-M, via the network 102. The web browser and/or other applications are generally running on the clients 108-1 through 108-N, while information generally resides on the servers 104-1 through 104-M. For ease of explanation, a single client 108-1 will be considered to illustrate one embodiment of the present techniques. It will be readily apparent that such techniques can be easily applied to multiple clients.

A subsystem may be, but is not limited to, one or more of the elements of FIG. 2. For example, Storage 210 may have a subsystem that handles how data is to be stored and retrieved. Audio 222 may have a subsystem that handles when to, for example, power down speakers. Communications device 230 may, for example, have a subsystem that needs to transfer information to the Storage 210 without using the main operating system upon receiving a message.

Additionally, subsystems and/or entire systems, in order to allow for upgrades and/or replacement without completely powering down may need hot plug capability. Because of the variety of connection possibilities, and the time varying nature of such insertions and/or removals, it is advisable to have the operating system and/or applications be aware of the actual physical connection and device connectivity so as to be able to effectively and efficiently use the devices. Thus, determination of actual device connectivity within a system and/or subsystem is beneficial. Existing bus specification PCI 2.2 Local Bus Specification provides a mechanism for detecting and enumerating PCI devices but restricts the type of physical connectivity between these devices.

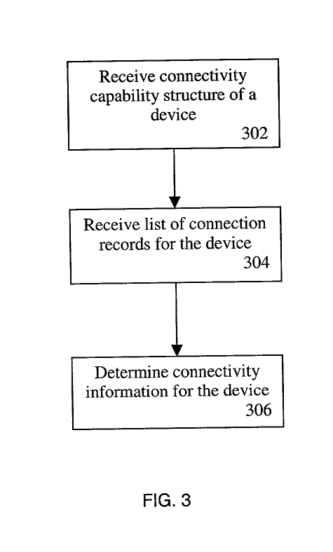

FIG. 3 illustrates in block diagram form an embodiment for determining device connectivity 300. First, at 302, information is received in the form of a connectivity capability structure of a device. Next, information is received in the form of a list of connection records for the device 304. Then at 306, the connectivity information for the device is determined by analyzing the list of connection records for the device. These structures are mechanisms whereby the connectivity information of a device can be communicated. For example, the structure may be, but is not limited to, information stored in PCI configuration space, in memory, etc.

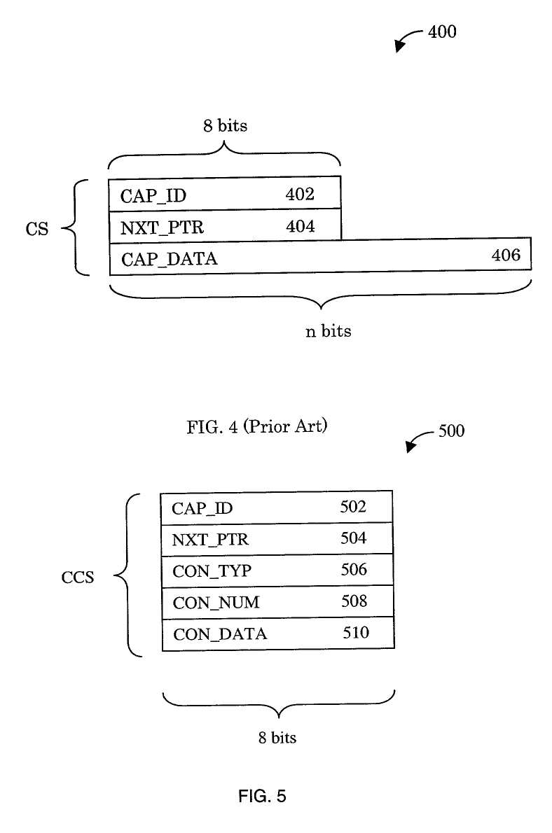

FIG. 4 illustrates an existing capability structure mechanism 400 provided in the PCI bus specification, Rev 2.2 to provide the OS with information about additional capabilities supported by a PCI device. The capability structure (CS) consists of three entries. The first, CAP_ID 402 is 8 bits wide and is a capability identification entry. The second entry NXT_PTR 404, is also 8 bits wide, and is a pointer to the next capability structure or NULL if there are no more capability structures. The third entry is CAP_DATA 406 that is n bits wide and represents Capability Data associated with this capability. n is a variable size. As illustrated here it happens to be wider than 8 bits.

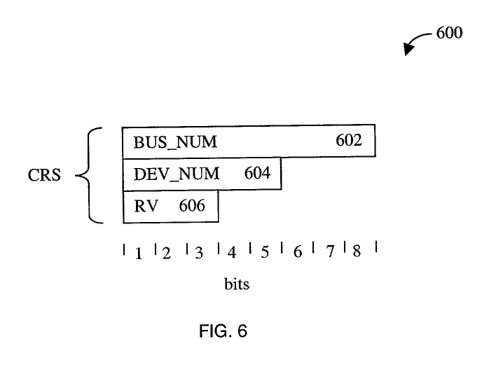

FIG. 5 illustrates an embodiment of a connectivity capability structure (CCS) 500. Here, the CCS format has five row elements, CAP_ID 502, NXT_PTR 504, CON_TYP 506, CON_NUM 508, and CON_DATA 510, each of which is composed of 8 bits. In this example embodiment, the CAP_ID 502 field contains identification of the connectivity capability. The specific value may be assigned by, for example, an industry standard group such as the PCI SIG (Special Interest Group). NXT_PTR 504 may be, for example, a pointer to the next capability structure or NULL if there are no more capability structures for this particular PCI device. CON_TYP 506 may describe a specific type of connectivity based on specific actions system software may need to take based on the connection type. CON_NUM 508 may represent the number of connectivity ports for this device. This may indicate the number of devices to which this device is connected. System software will use this number to determine the number of connection records to parse at the location pointed to by the connection data CON_DATA 510. CON_DATA 510 may represent the offset into the configuration space of the device where the connection records for this device are located. System software may parse CON_NUM 508 of connection records (one format shown in FIG. 6) starting at an offset provided by CON_DATA 510.

Since the CCS can specify connectivity among PCI devices, identifying the devices that the PCI device is connected to by the PCI bus and device number is sufficient. Note that even though a target multi-function device may have multiple functions, the connectivity may be identical for all the functions and hence it may be sufficient to not include function information in the connectivity. Similarly, it may be sufficient to include the connectivity information in one of the functions of the multi-function device. Thus, the connection record may have the format as illustrated in FIG. 6.

FIG. 6 illustrates an embodiment of a connection record structure (CRS) 600. In this embodiment there are three entries. BUS_NUM 602 is 8 bits wide and may represent the bus number of the target PCI device. DEV_NUM 604 is 5 bits wide and may represent the device number of the target PCI device on the BUS_NUM 602 bus. RV 606 is a reserved field of 3 bits. This reserved field RV 606 may be used for providing specific information about this link, etc.

Thus, for example, a computer program and/or operating system, by using information in the connectivity capability structure 500 in conjunction with information in the list of connection records pointed to by the connectivity capability structure field (CON DATA) may be able to determine the connectivity information necessary for supporting hot plug (without relying on static BIOS based mechanisms such as device hierarchies provided in ACPI (Advanced Configuration and Power Interface Specification) tables).

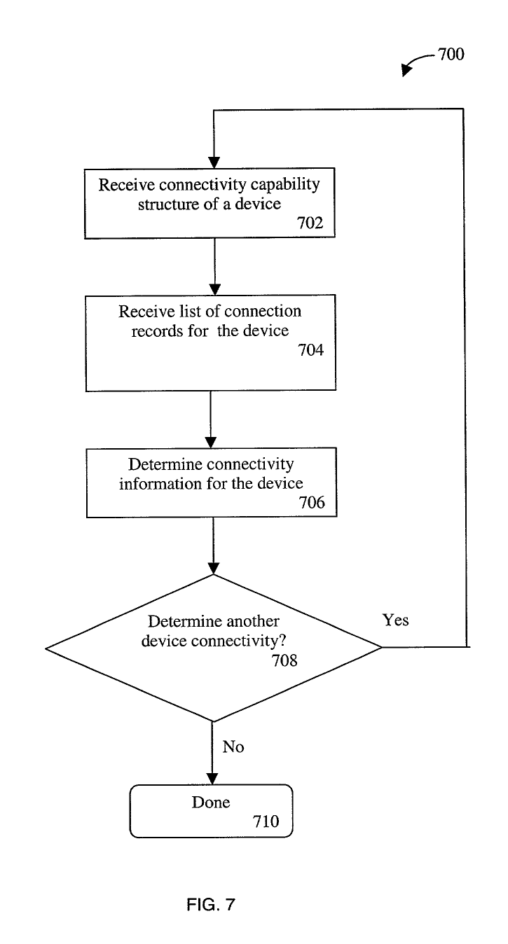

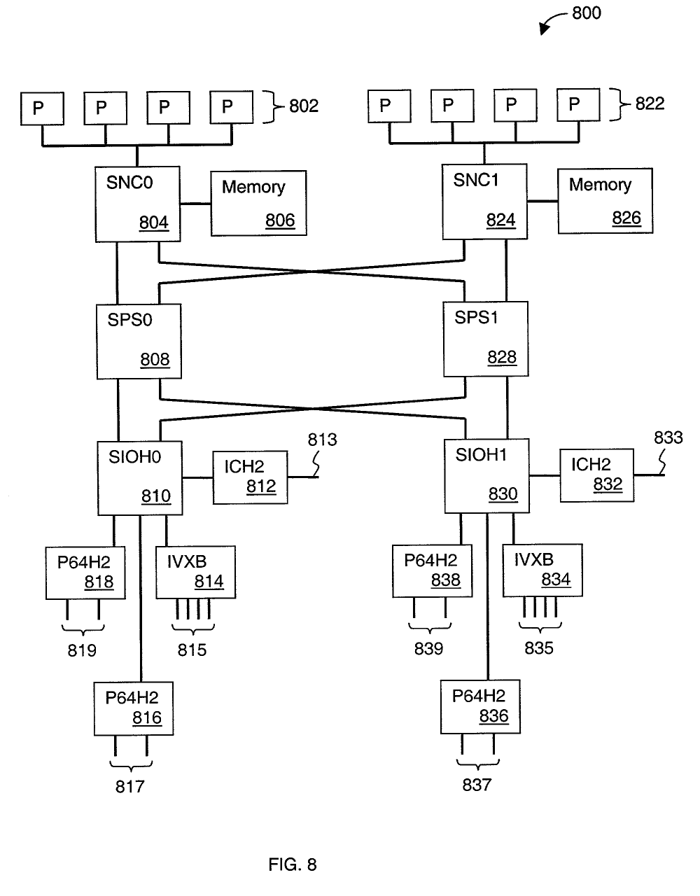

FIG. 7 illustrates in block diagram form one embodiment for determining multiple device connectivity 700. Here, at 702 information is received in the form of a connectivity capability structure of a device. Next, information is received in the form of a list of connection records for the device 704. At 706, the connectivity information for the device is determined. Then at 708 a check is made to see if another device connectivity needs to be determined 708. If not, then the device connectivity determination is done 710. If another device connectivity needs to be determined then 702, 704, and 706 are repeated for another device.

FIG. 8 illustrates one embodiment of a system 800 where the present invention may be practiced. FIG. 8 is a block diagram illustration of an 8-way server architecture. Four processors (P) 802 are linked to a Scalable Node Controller (SNC0) 804 and four other processors (P) 822 are linked to SNC1 824. SNC0 804 controls the interfaces to the switches SPS0 808 and SPS1 828, and also is a memory controller interfacing to the memory 806. Likewise, SNC1 824 controls the interfaces to the switches SPS1 828 and SPS0 808, and also is a memory controller interfacing to the memory 826. The switches SPS0 808 and SPS1 828 are Scalability Port Switches (SPS) and act as a switch between compute (processor-memory) nodes (802, 804, 806; and 822, 824, 826) and 10 nodes (SIOH0 810, and SIOH1 830).

The Server I/O Hubs (SIOH), SIOH0 810 and SIOH1 830 serve as root-PCI bridges. SIOH0 810 and SIOH1 830 link respectively to I/O controller Hub 2 (ICH2) 812 and 832. ICH2 812 links via 813, and ICH2 832 links via 833, to, for example, various legacy devices, such as, USB devices, AC'97 devices, etc. ICH2 812 and ICH2 832 may also control power management interfaces.

SIOH0 810 and SIOH1 830 also link to PCI-IBA (infiniband) bridges, IVXB 814 and 834 and via links 815 and 835 to devices. Also shown in this embodiment, SIOH0 810 and SIOH1 830 also link to PCI 64 Hub2 devices (P64H2) 816, 818, and 836, 838. The P64H2 has two PCI to PCI bridges, two PCI Hot Plug controllers and two I/O Advanced Programmable Interrupt Controllers. Thus, P64H2 816 interfaces to devices via links 817, P64H2 818 interfaces to devices via links 819, P64H2 836 interfaces to devices via links 837, and P64H2 838 interfaces to devices via links 839.

What is to be appreciated is that in a system, such as that illustrated in FIG. 8, the connectivity of hot plugged devices is important for system performance. For example, if a fully functional system were to have, say, the same type of I/O device connected at ports 819 and 839 and one were to fail, then the removal of that I/O device may influence how the OS routes information via SPS0 808 and/or SPS1 828. That is, the OS may, if the I/O device connected for example at 839 is no longer functional, decide to route the information to the I/O device attached at 819. This might be accomplished by routing the information from SPS1 828 to SIOH0 810 rather than to SIOH1 830.

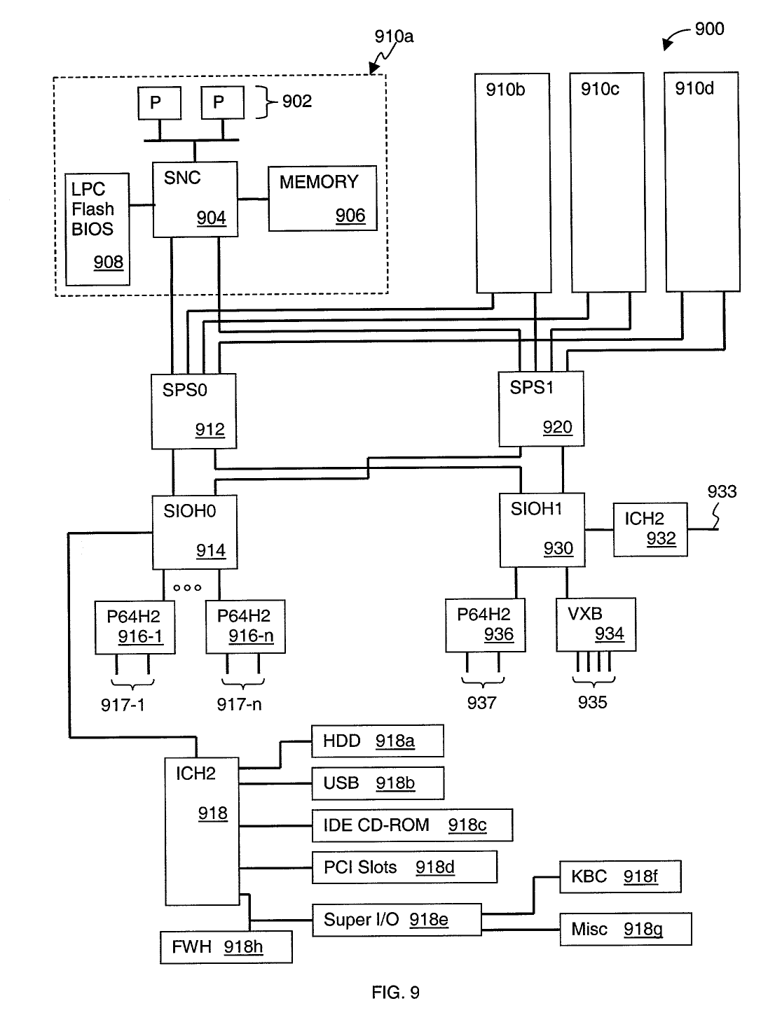

FIG. 9 illustrates another embodiment of a system 900 where the present invention may be practiced. FIG. 9 is a block diagram illustration of an 8-way server system architecture with four, two processor nodes. The four processor nodes are 910a-d. Node 910a is illustrated in more detail where two processors (P) 902 are linked to a Scalable Node Controller (SNC) 904 as well as a memory 906 and a LPC (low pin count) flash bios 908. Note that the processors (P) may also have available a local memory for their own use, such as a Level 2 cache. SNC 904 interfaces to the switches SPS0 912 and SPS1 920. Likewise, the other nodes, 910b-d have SNCs that interface to the switches SPS0 912 and SPS1 920, and also the processors P, memory, and an LPC flash bios. The switches SPS0 912 and SPS1 920 are Scalability Port Switches (SPS) and act as a switch between compute (processor-memory) nodes (910a-b) and 10 nodes (SIOH0 914, and SIOH1 930).

The Server I/O Hubs (SIOH), SIOH0 914 and SIOH1 930 serve as root-PCI bridges. SIOH0 914 and SIOH1 920 link respectively to I/O controller Hub 2 (ICH2) 918 and 932. ICH2 918 has links to a variety of possible devices and/or busses. Examples are, hard disk drives (HDD) 918a, USB 918b, IDE CD-ROM 918c, PCI slots 918d, Super I/O 918e and firmware hub FWH 918h. Note that these devices and/or busses may have connected to them other devices and/or busses. For example, Super I/O 918e has connected to it a keyboard controller KBC 918f, and miscellaneous (Misc) devices 918g. These miscellaneous devices migh be, for example, various legacy devices, such as, AC'97 devices, power control management devices, etc. Likewise, ICH2 932 may interface via link 933 to various devices and/or busses.

SIOH1 930 is shown linking to a VXB 934 bridge with links 935. The VXB 934 may be, for example, an NGIO bridge (Next Generation I/O) with links 935 representing NGIO channels. Also shown in this embodiment, SIOH0 914 and SIOH1 930 also link to PCI 64 Hub2 devices (P64H2) 916-1 through 916-n, and 936. The P64H2 has two PCI to PCI bridges, two PCI Hot Plug controllers and two I/O Advanced Programmable Interrupt Controllers. Thus, P64H2 916-1 through 916-n would interface to devices via links 917-1 through 917-n respectively.

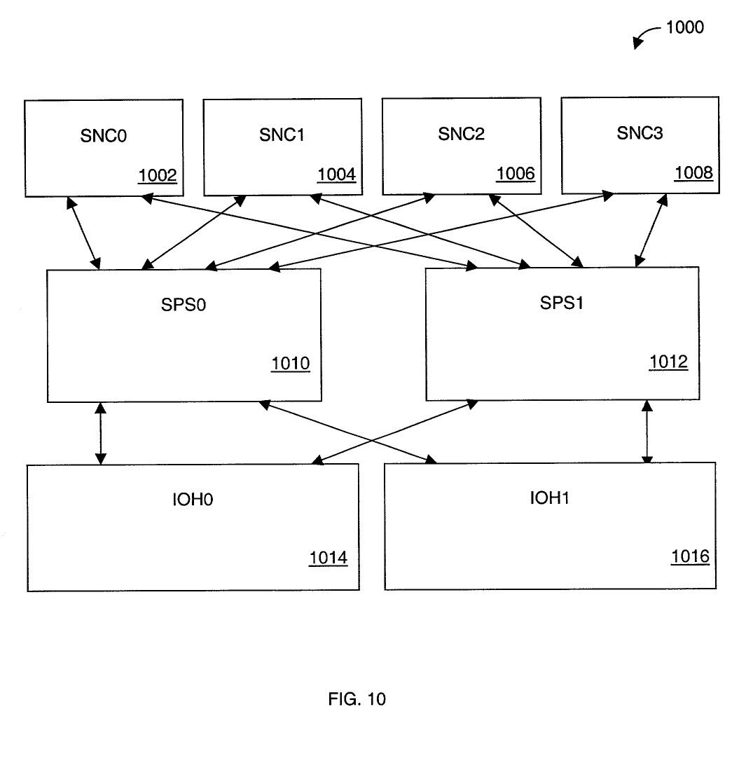

FIG. 10 illustrates a bus hierarchy 1000 for one embodiment of a system configuration. Here, four node SNCs are denoted as SNC0 1002, SNC1 1004, SNC2 1006, and SNC3 1008. Two SPSs are denoted as SPS0 1010 and SPS1 1012. Each SNC (1001-1008), is connected to each SPS 1010 and 1012. Next, each SPS 1010 and 1012 is connected to each IOH (I/O Hub) IOH0 1014 and IOH1 1016. Here, each SNC, SPS, and IOH may contain registers for holding information such as node id, bus type, etc. Additionally the IOHs may be connected to other busses, for example, a series of PCI busses through such devices as bridges, hub links, etc.

What is to be appreciated from the illustration in FIG. 10 is the ability via the information that is accessible to determine connectivity information. This connectivity information may be obtained dynamically, allowing the operating system and/or software to determine the graph-based connectivity of the PCI devices.

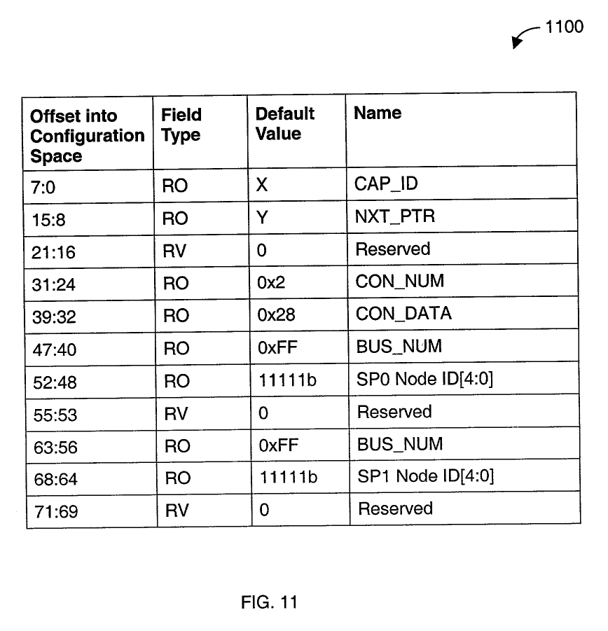

FIG. 11 illustrates one embodiment of a connectivity capability structure 1100 in the configuration space. This connectivity capability structure may be used, for example, for a scalable node controller (SNC), where the SNC has connectivity to two other devices. Such an example is in FIG. 10, where each SNC has connections to the two switches SPS0 1010 and SPS1 1012. The two SNC connections (connectivity ports) are referred to as the SP0 (for SPS0) and the SP1 (for SPS1) links. Each SNC device in FIG. 10 may have an identical connectivity capability structure. FIG. 11 has four columns denoting: offset into configuration space; the field type, either read only (RO) or reserved (RV); default value; and the name of the field.

CAP_ID is the capability identification value. This value may be assigned by the manufacturer and/or by an industrial standards groups, such as PCI SIG.

NXT_PTR is the offset of the next capability structure or NULL if there are no other capability structures.

Offset 21:16 a reserved field is for future extension. Possible future uses for this field may indicate type of connectivity, such as system bus to system bus, system bus to I/O bus, etc.

CON_NUM represents the number of connectivity ports for this device. In the example of FIG. 10 each SNC has two connectivity ports.

CON_DATA represents the offset in configuration space where the connection records are located. For the SNC in FIG. 10, the connectivity records start at offset 40.

BUS_NUM field, offset space 47:40, is for the connectivity record for the SP0 link. In this example, the bus number is 0xFF.

SP0 Node ID[4:0] field is, for example, the device number received from SPS0.

Offset 55:53 field is reserved for future extension.

BUS_NUM field, offset space 63:56, is for the connectivity record for the SP1 link. In this example, the bus number is 0xFF.

SP1 Node ID[4:0] field is, for example, the device number received from SPS1.

Offset 71:69 field is reserved for future extension.

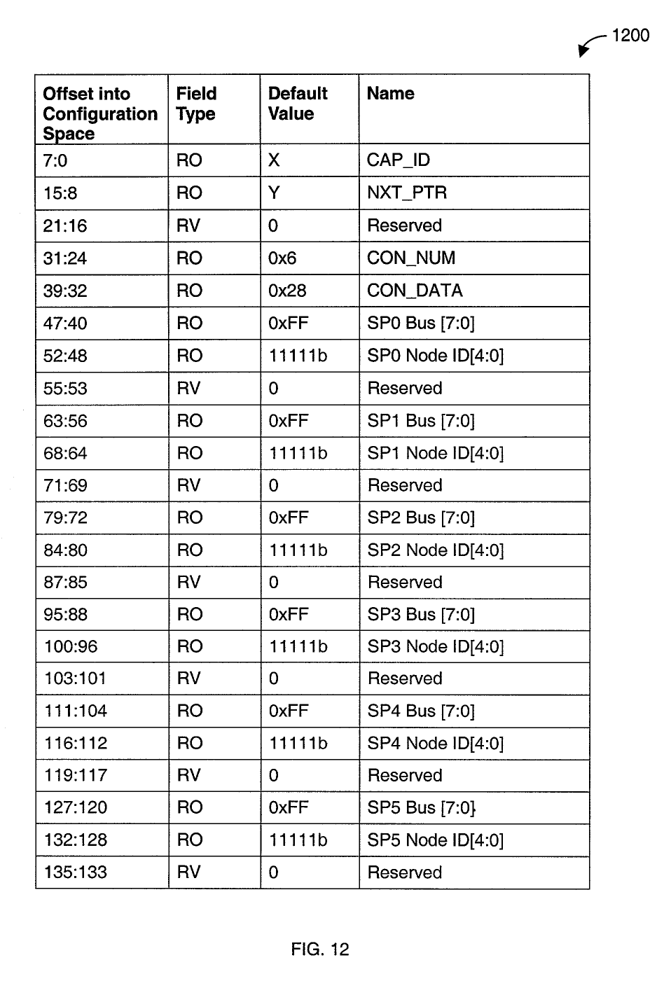

FIG. 12 illustrates another embodiment of a connectivity capability structure 1200 in the configuration space. This connectivity capability structure may be used, for example, for a scalability port switch (SPS), where the SPS has connectivity to six other devices. Such an example is in FIG. 10, where each SPS is connected to four SNC devices and two IOH devices. The links are referred to as SP0, SP1, SP2, SP3, SP4 and SP5. Each SPS may have an identical structure.

FIG. 12 has four columns denoting: offset into configuration space; the field type, either read only (RO) or reserved (RV); default value; and the name of the field.

CAP_ID is the capability identification value. This value may be assigned by the manufacturer and/or by an industrial standards group, such as PCI SIG.

NXT_PTR is the offset of the next capability structure or NULL if there are no other capability structures.

Offset 21:16 field is reserved for future extension. Possible future uses for this field may indicate type of connectivity, such as system bus to system bus, system bus to I/O bus, etc.

CON_NUM represents the number of connectivity ports for this device. In the example of FIG. 10 each SPS has six connectivity ports.

CON_DATA represents the offset in configuration space where the connection records are located. For the SPSs in FIG. 10, the connectivity records start at offset 40.

SP0 Bus [7:0] is the connectivity record for SP0. The bus number may be received from SNC0. In this example, the bus number is 0xFF.

SP0 Node ID[4:0] field is, for example, the device number received from SNC0. In this example, the value is 11111b,

Offset 55:53 field is reserved for future extension.

In a similar fashion, the fields for SP2 and SP3 bus and node ID, as well as reserved fields are detailed in FIG. 12 and may receive numbers from the respective SNC.

SP4, and SP5 bus and node ID, as well as reserved fields are detailed in FIG. 12 and may receive bus and device numbers from IOH0 1014 and IOH1 1016 respectively.

In FIG. 10, the connectivity structure for the IOH0 1014 and/or IOH1 1016 may be as shown in FIG. 11 because the IOHs have connectivity to two other devices, the switches SPS0 1010 and SPS1 1012. The links are referred to as the SP0 (for SPS0 1010) and the SP1 (for SPS1 1012) links. Each IOH device in FIG. 10 may have an identical connectivity capability structure. All of the fields listed in FIG. 11 have been discussed above. For example, CON_NUM indicates the number of connectivity ports for this device, in this example, each IOH has two connectivity ports.

It is to be appreciated that the architecture and functionality described above may have other embodiments. For example, in FIG. 8 the PCI hubs (P64H2) have two PCI to PCI bridges, two PCI Hot Plug controllers and two I/O Advanced Programmable Interrupt Controllers. Other combinations of functionality are possible, for example, a different number of PCI bridges, hot plug controllers, etc.

Finally, it is to be appreciated that no temporal restrictions have been placed on the method and apparatus described. Thus, the determination of connectivity may by viewed as dynamic. For example, the OS may, on a timed basis, determine the connectivity, or the insertion and/or removal of a device may initiate a connectivity determination.

Certain details of the PCI (Peripheral Component Interconnect) specification have not been detailed here in order to avoid obscuring the present invention. More details are available in the following specifications: PCI Local Bus Specification, Revision 2.2, Dec. 18, 1998; PCI-to-PCI Bridge Architecture Specification, Revision 1.1, Dec. 18, 1998; and Advanced Configuration And Power Interface Specification, Rev 2.0, Jul. 27, 2000.

Thus, a method and apparatus for the dynamic detection of graph-based connectivity among PCI (Peripheral Component Interconnect) devices have been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method comprising:
receiving a connectivity capability structure of a device;
receiving a list of connection records for the device; and
determining connectivity information for the device.

2. The method according to claim 1, wherein the device is a Peripheral Component Interconnect (PCI) device.

3. The method according to claim 2, wherein the connectivity capability structure is an indicator of a type of connection from a current PCI device.

4. The method according to claim 3, wherein the connectivity capability structure further comprises an indicator for a number of connectivity ports on the PCI device.

5. The method according to claim 1, wherein the connectivity capability structure comprises:
a capability identifier;
a pointer to a next capability structure;
an indicator of a type of connection from a current device;
an indicator of a number of connectivity ports on a device; and
an indicator of a location of a number of connection records on a device.

6. An apparatus comprising:
a device; and
a processor coupled to the device for retrieving information on a connectivity capability structure of the device, and retrieving information on a list of connection records of the device.

7. The apparatus of claim 6, further comprising an operating system executing on the processor.

8. The apparatus of claim 6, wherein the device is a PCI device.

9. A machine-readable medium having stored thereon instructions, which when executed by a processor, causes said processor to perform the following:
receive a connectivity capability structure of a device;
receive a list of connection records for the device; and
determine connectivity information for the device.

10. The machine-readable medium according to claim 9, wherein receiving the connectivity capability structure of the device is receiving the connectivity capability structure of a PCI device.

11. The machine-readable medium according to claim 10, wherein receiving the connectivity capability structure of the PCI device comprises receiving an indicator of a type of connection from a current PCI device.

12. A system comprising:
a plurality of processors;
a plurality of devices coupled to the plurality of processors;
a first memory coupled to the processor and containing a connectivity capability structure for the plurality of devices coupled to the plurality of processors; and
a second memory coupled to the processor and containing a list of connection records for the plurality of devices coupled to the plurality of processors.

13. The system of claim 12, wherein the plurality of devices is a plurality of PCI devices.

14. The system of claim 12, wherein the first memory and the second memory are a single memory storage device.

15. An apparatus comprising:
a processor; and
a memory coupled to the processor, the memory comprising:
data on a capability identification of a first device coupled to the processor;
data on a pointer to a next capability structure of a second device coupled to the processor;
data on a connectivity type for the first device;
data on a number of connectivity ports for the first device; and
data on the location of a number of connection records for the first device.

16. The apparatus of claim 15, wherein the first device and the second device are PCI devices.

17. The apparatus of claim 15, wherein the apparatus further comprises a plurality of devices coupled to the processor.

18. An apparatus comprising:
means for receiving a connectivity capability structure of a device;
means for receiving a list of connection records for the device; and
means for determining connectivity information for the device.

19. The apparatus of claim 18, wherein means for receiving is a means for receiving from a memory device.

20. The apparatus of claim 18, wherein means for determining connectivity information for the device further comprises means for extracting information from the connectivity capability structure and the list of connection records to determine the connectivity information for the device.

21. A method comprising:
(a) inputting connectivity capability structure data of a device;
(b) inputting list of connection records data of the device; and
(c) determining a connectivity of the device. repeating the sequence (a)-(c) for a plurality of devices.

22. The method of claim 21 wherein the devices are PCI devices.

23. The method of claim 21 wherein the method is performed dynamically.
